(19) United States
(12) Patent Application Publication
(10) Pub. No.: US 2016/0104448 A1
(43) Pub. Date: Apr. 14, 2016

(54) DISPLAY APPARATUS

(71) Applicant: Samsung Display Co., Ltd., Yongin-City, Gyeonggi-Do (KR)

(72) Inventors: Sunhwa LEE, Yongin-si (KR); Kwang-Chul JUNG, Seongnam-si (KR); Meehye JUNG, Suwon-si (KR)

(21) Appl. No.: 14/744,340

(22) Filed: Jun. 19, 2015

(30) Foreign Application Priority Data
Oct. 8, 2014 (KR) 10-2014-0135981

(51) Int. Cl. G09G 3/36; G09G 5/18; G09G 5/02

(52) U.S. Cl. CPC G09G 3/3696; G09G 5/02; G09G 5/18; G09G 2300/0426

(57) ABSTRACT

A display apparatus including a display panel comprises a plurality of pixel sets, wherein each of the plurality of pixel sets comprises a plurality of pixel rows formed of 8i pixels (where i is a natural number) and each of the pixels is any one of first to fourth pixels displaying different colors. Pixels displaying identical color in a first pixel row among the pixel rows of each of the plurality of pixel sets have identical polarity, and have polarities different from those of pixels displaying identical color and disposed in a second pixel row adjacent to the first pixel row. Polarities of the pixels displaying identical color in each pixel row are inverted in a unit of one pixel set.

### CLAIM OF PRIORITY

This U.S. non-provisional patent application claims priority under 35 U.S.C. §119 of Korean Patent Application No. 10-2014-0135981 filed on Oct. 8, 2014, the entire contents of which are hereby incorporated by reference.

### BACKGROUND IF THE INVENTION

The present invention herein relates to a display apparatus and a driving method thereof, and more particularly, to a display apparatus capable of improving display quality.

Typical displays represent colors using three primary colors of red, green, and blue. Accordingly, a display panel used for the typical display includes red, green, and blue pixels displaying red, green, and blue colors.

Recently, a display device is being developed which displays color using red, green, blue and auxiliary colors. The auxiliary color may be any one of magenta, cyan, yellow, and white, or two or more of them. In addition, in order to improve luminance of a displayed image, a display device is being developed which includes red, green, blue, and white pixels. Such a display device receives red, green, and blue image signals and converts them into red, green, blue, and white data signals.

The converted red, green, blue, and white data signals are provided to corresponding red, green, blue, and white pixels, respectively. As a result, an image is displayed by the red, green, blue, and white pixels.

### SUMMARY ON THE INVENTION

The present invention provides a display device capable of improving display quality by improving a moving line mura phenomenon and a horizontal crosstalk phenomenon.

Embodiments of the invention provide display apparatuses having a display panel comprising a plurality of pixel sets, wherein each of the plurality of pixel sets comprises a plurality of pixel rows formed of 8i pixels (where i is a natural number), and each of the pixels is any one of first to fourth pixels displaying different colors. Pixels displaying identical color in a first pixel row among the pixel rows of each of the plurality of pixel sets have identical polarity, and have different polarities from those of pixels displaying identical color and disposed in a second pixel row adjacent to the first pixel row, and polarities of the pixels displaying identical color in each pixel row are inverted in a unit of one pixel set.

In some embodiments, the plurality of pixel sets may include first and second pixel sets disposed adjacent to each other in a row direction, and polarities of pixels arrayed in a j-th pixel column (where j is a natural number) of the first pixel set are opposite to those of pixels arrayed in a j-th pixel column of the second pixel set.

In other embodiments, the first pixel set may include a plurality of first pixel groups groups having 4k pixel columns (where k is a natural number) and the second pixel set may include a plurality of second pixel groups having 4k pixel columns, and polarities of pixels arrayed in an l-th pixel column (where l is a natural number) of the first pixel group are opposite to those of pixels arrayed in an l-th pixel column of the second pixel group.

In still other embodiments, k may be 1, first to fourth pixels in each first pixel row of the first and second pixel groups are provided in the order of the first, second, third, and fourth pixels, and first to fourth pixels in each second pixel row of the first and second pixel groups are provided in the order of third, fourth, first, and second pixels.

In even other embodiments, an array of polarities in the row direction of the pixel columns of the first pixel group may be “+−+” and an array of polarities in the row direction of the pixel columns of the second pixel group may be “−++−”.

In yet other embodiments, the first to fourth pixels may display red, green, blue, and white, respectively.

In further embodiments, the display apparatus may further include a data driving unit applying data voltages to the pixel columns, respectively.

In still further embodiments, the data driving unit may provide data voltages having different polarities in a unit of two pixel columns.

In even further embodiments, the data driving unit may inverts the polarities of the data voltages for each frame.

In yet further embodiments, the display apparatus may further include a timing controller comprising a gamma mapping unit for mapping image information having three primary colors received from outside to create RGBW signals, and a sub pixel rendering unit for converting the RGBW signals into output image data through resample filtering, wherein the data driving unit converts the output image data into the data voltages.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a schematic block diagram of a display apparatus according to an embodiment of the invention;

FIG. 2 is an equivalent circuit diagram of one pixel illustrated in FIG. 1;

FIG. 3 is a block diagram of a timing controller illustrated in FIG. 1;

FIG. 4 is a plan view illustrating a part of a display panel according to an embodiment of the invention;

FIG. 5 shows driving states of pixels for displaying any one primary color among pixels illustrated in FIG. 4.

FIG. 6 is a view illustrating a driven state of pixels when primary colors are displayed on any portion of pixel rows among pixels illustrated in FIG. 5;

FIG. 7 is a plan view illustrating a part of a display panel according to another embodiment of the invention; and

FIG. 8 is a view illustrating a driven state of pixels when primary colors are displayed on any portion of pixel rows among pixels illustrated in FIG. 7.

### DETAILED DESCRIPTION OF THE INVENTION

Exemplary embodiments of the invention will be described below in more detail with reference to the accompanying drawings. The invention may, however, be embodied in different forms and should not be construed as limited to the embodiments set forth herein. Rather, these embodiments are provided so that this disclosure will be thorough and complete, and will fully convey the scope of the invention to those skilled in the art.

Advantages and features of the present invention and methods for achieving the same will be clear with reference to exemplary embodiments described later in detail together with the accompanying drawings. However, the present invention is not limited to the following exemplary embodiments, but is realized in various forms. In other words, the present exemplary embodiments are provided just to provide a complete disclosure the present invention and to enable a person having an ordinary skill in the art understand the scope of the invention. The present invention should be defined only by the scope of the accompanying claims. Throughout this specification, like numerals refer to like elements.

When an element or a layer is referred to as being ‘on’ another element or layer, it can be directly on the other element or layer, or intervening layers or elements may also be present. In contrast, when an element or layer is referred to as being “directly on” another element or layer, there are no intervening elements or layers present. The term “and/or” includes any and all combinations of one or more of the associated listed items.

Spatially relative terms, such as “above,” “upper,” “beneath,” “below,” “lower,” and the and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. Throughout this specification, like numerals refer to like elements.

Also, although terms like “first” and “second” are used to describe various members, components, and/or sections in various embodiments of the present invention, the members, components, and/or sections are not limited to these terms. These terms are used only to differentiate one member, component, or section from another one. Therefore, a first member, a first component, or a first section referred to below can be referred to as a second member, a second component, or a second section within the technical spirit of the present invention.

Exemplary embodiments are described herein with reference to cross-sectional views and/or plan views that are schematic illustrations of exemplary embodiments. As such, variations from the shapes of the illustrations as a result, for example, of manufacturing techniques and/or tolerances, are to be expected. Thus, exemplary embodiments should not be construed as limited to the particular shapes of regions illustrated herein but may be construed to include deviations in shapes that result, for example, from manufacturing. Thus, the regions illustrated in the figures are schematic in nature and their shapes may be intended to illustrate the actual shape of a region of a device and are not intended to limit the scope of exemplary embodiments.

Hereinafter, an exemplary embodiment of the present invention will be described in detail in conjunction with the accompanying drawings.

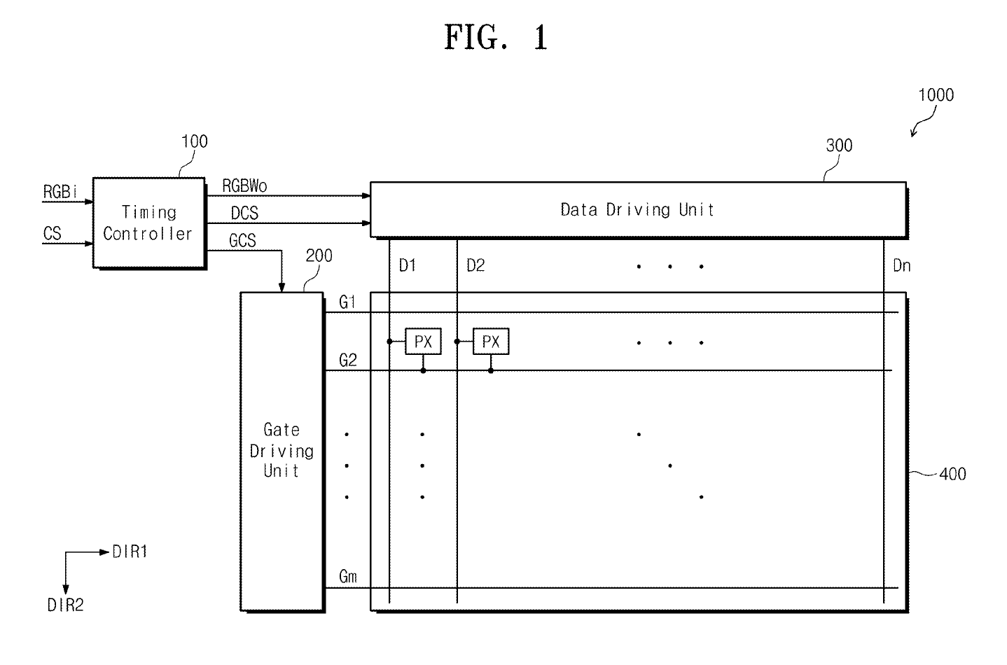

FIG. 1 is a schematic block diagram of a display apparatus according to an embodiment of the invention.

Referring to FIG. 1, a display apparatus 1000 includes a display panel 400 for displaying an image, a gate driving unit 200 and a data driving unit 300 for driving the display panel 400, and a timing controller 100 for controlling operation of the gate driving unit 200 and the data driving unit 300.

The timing controller 100 receives input image information RGBi and a plurality of control signals CS from outside the display device 1000. The timing controller 100 converts a data format of the input image information RGBi to create an output image data RGBWo to be matched with the interface specification of the data driving unit 300, and provides the output image data RGBWo to the data driving unit 300.

In addition, the timing controller 100 creates a data control signal DCS (e.g., an output start signal, a horizontal start signal and the like) and a gate control signal GCS (e.g., a vertical start signal, a vertical clock signal, and a vertical clock bar signal) based on the plurality of control signals CS. The data control signals DCS are provided to the data driving unit 300 and the gate control signals GCS are provided to the gate driving unit 200.

The gate driving unit 200 sequentially outputs the gate signals in response to the gate control signals GCS provided by the timing controller 100.

The data driving unit 300 converts the output image data RGBWo into data voltages to output the converted data voltages to the display panel 400 in response to the data control signals DCS provided from the timing controller 100.

The display panel 400 includes a plurality of gate lines G1 to Gn, a plurality of data lines D1 to Dm, and a plurality of pixels PX.

The pixels PX are elements displaying basic unit images forming an image and resolution of the display panel 400 may be determined according to the number of the pixels PX included in the display panel. Two pixels PX are illustrated in FIG. 1 and illustration of the other pixels is omitted.

Each pixel PX may display one of the primary colors. The primary colors may include red, green, blue, and white. However, the primary colors are not limited thereto and may further include various colors such as yellow, cyan, and magenta.

The plurality of gate lines G1 to Gn are extended in a first direction DIR1 and arrayed in parallel in a second direction DIR2 which is perpendicular to the first direction DIR1. The plurality of gate lines G1 to Gn are connected to the gate driving unit 200 and sequentially receive the gate signals from the gate driving unit 200. In an example of an embodiment of the invention, the gate signals may be sequentially provided to the gate lines G1 to Gn along the second direction DIR2.

The plurality of data lines D1 to Dm are extended in the second direction DIR2 and arrayed in parallel in the first direction DIR1. The plurality of data lines D1 to Dm are connected to the data driving unit 300 and receive the data voltages from the data driving unit 300.

The pixels PX may be connected to corresponding gate lines among the gate lines G1 to Gn and corresponding data lines among the data lines D1 to Dm. In detail, the pixels PX may be turned on or tuned off by the applied gate signals. The turned-on pixels PX display gradations corresponding to the applied data voltages.

A polarity of a data voltage applied to each of the pixels PX may be inverted for each frame in order to prevent degradation of liquid crystals included in the display panel 400. For example, the data driving unit 300 may reverse and output the polarities of the data voltages for each frame in response to a reversal signal (not shown) included in the data control signals DCS. In addition, when an image of one frame is displayed, data voltages having different polarities are outputted in a unit of two data lines and are provided to the pixels PX for improving display quality.

The timing controller 100 may be mounted on a printed circuit board in an integrated circuit chip type and is connected to the gate driving unit 200 and the data driving unit 300. The gate driving unit 200 and data driving unit 300 may be formed of a plurality of driving chips to be mounted on a flexible printed circuit board, and may be connected to the display panel 400 in the form of a tape carrier package (TCP).

However, the invention is not limited thereto, and the gate driving unit 200 and data driving unit 300 are formed of a plurality of driving chips to be mounted on the display panel 400 in the form of a chip on glass (COG). Furthermore, the gate driving unit 200 may be simultaneously formed with transistors of the pixels PX and may be mounted on the display panel in the form of an amorphous silicon TFT gate driver circuit (ASG).

The display panel 400 may be a liquid crystal display panel including a liquid crystal layer disposed between two opposing substrates. In this case, although not illustrated in FIG. 1, a backlight unit providing light to the display panel 400 may be further provided on a rear surface of the display panel 400.

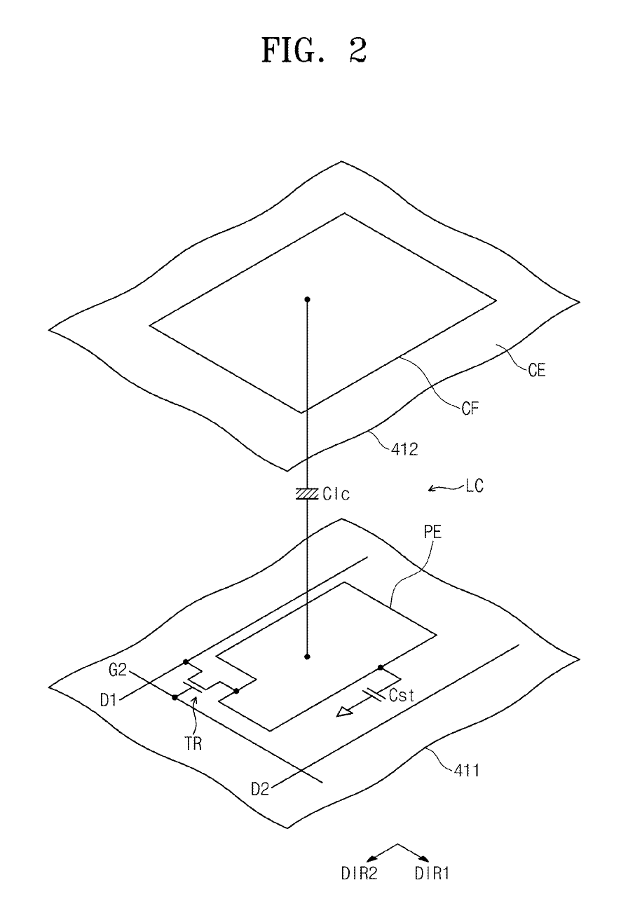

FIG. 2 is an equivalent circuit diagram of one pixel illustrated in FIG. 1.

For convenience of explanation, a pixel PX connected to a second gate line G2 and a first data line D1 is illustrated in FIG. 2. Although not illustrated in the drawing, configurations of other pixels PX of the display panel 400 may be substantially the same as that of the pixel PX illustrated in FIG. 2.

Referring FIG. 2, the display panel 400 includes a first substrate 411, a second substrate 412 facing the first substrate 411, and a liquid crystal layer LC disposed between the first and second substrates 411 and 412.

The pixel PX includes a transistor TR connected to the second gate line G2 and the first data line D1, a liquid crystal capacitor Clc connected to the transistor TR, and a storage capacitor Cst connected in parallel with the liquid crystal capacitor Clc. The storage capacitor Cst may be omitted.

The transistor TR may be disposed on the first substrate 411. The transistor TR includes a gate electrode connected to the second gate line G2, a source electrode connected to the first data line D1, and a drain electrode connected to the liquid crystal capacitor Clc and the storage capacitor Cst.

The liquid crystal capacitor Clc includes a pixel electrode PE disposed on the first substrate 411, a common electrode CE disposed on the second substrate 412, and the liquid crystal layer LC disposed between the pixel electrode PE and the common electrode CE. In this case, the liquid crystal layer LC plays a role as a dielectric. The pixel electrode PE is connected to the drain electrode of the transistor TR.

The common electrode CE may be entirely formed on the second substrate 412. However, the invention is not limited thereto and the common electrode CE may be disposed on the first substrate 411. In this case, at least one of the pixel electrode PE and the common electrode CE may include a slit.

The storage capacitor Cst may include the pixel electrode PE, a storage electrode (not shown) branched from a storage line (not shown), and an insulation layer disposed between the pixel electrode PE and the storage electrode. The storage line is disposed on the first substrate 411 and may be simultaneously formed on the same layer as the gate lines G1 to Gm. The storage electrode may be partially overlapped with the pixel electrode PE.

The pixel PX may further include a color filter CF representing one of the primary colors. In an exemplary embodiment, the color filter CF may be disposed on the second substrate 412 as illustrated in FIG. 2. However, the invention is not limited thereto, and the color filter CF may be disposed on the first substrate 411.

The transistor TR is turned on in response to the gate signal received through the second gate line G2. A data voltage received through the first data line D1 is provided to the pixel electrode PE of the liquid crystal capacitor Clc through the transistor TR turned on. A common voltage is applied to the common electrode CE.

An electric field is formed between the pixel electrode PE and the common electrode CE due to a voltage level difference between the data voltage and the common voltage. Liquid crystal molecules of the liquid crystal layer LC are driven by the electric field formed between the pixel electrode PE and the common electrode CE. The liquid crystal molecules driven by the formed electric field allow light transmittance to be adjusted and an image to be displayed.

A storage voltage having a constant voltage level may be applied to the storage line. However, the invention is not limited thereto and the storage line may receive the common voltage. The storage capacitor Cst plays a role of maintaining a voltage charged in the liquid crystal capacitor Clc.

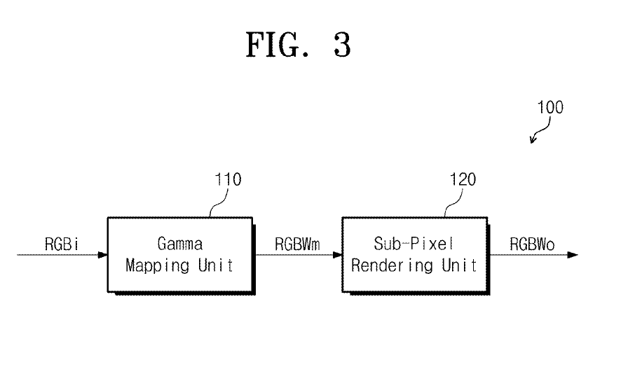

FIG. 3 is a block diagram of a timing controller illustrated in FIG. 1.

Referring to FIG. 3, the timing controller 100 includes a gamma mapping unit 110 and a sub pixel rendering unit 120.

The gamma mapping unit 110 maps the input image information RGBi to an RGBW signal RGBWm. The gamma mapping unit 110 maps an RGB gamut of the input image information RGBi to an RGBW gamut through a gamut mapping algorithm, (GMA) so as to create RGBW signal RGBWm. The signal RGBWm may be provided to the sub pixel rendering unit 120.

In addition, although not illustrated in detail in FIG. 3, the gamma mapping unit 110 may further create luminance data of the input image information RGBi besides the RGBW signal RGBWm. The luminance data may be provided to the sub pixel rendering unit 120 and used for a sharp filtering operation.

The sub pixel rendering unit 120 performs a rendering operation on the RGBW signal RGBWm to create output image data RGBWo. The rendering operation performed by the sub pixel rendering unit 120 may include resample filtering and sharp filtering.

The resample filtering is a process of creating data corresponding to a target pixel on the basis of data of the RGBW signal RGBWm corresponding to the target pixel and surrounding pixels adjacent to the target pixel among RGBW signal RGBWm.

In addition, the sub pixel rendering unit 120 may compensate for the output image data RGBWo through the sharp filtering after the resample-filtering. In detail, the sharp filtering may discriminate a line, an edge, a point, an oblique line and the like of the RGBW signal RGBWm so as to compensate for the output image data RGBWo, allowing the line, edge, point, oblique line and the like to be properly displayed.

Although not illustrated in FIG. 3, an input gamma converting unit may be further included at a previous stage of the gamma mapping unit 110. The input gamma converting unit adjusts and outputs a gamma characteristic of the input image information RGBi in order to make data processing in the subsequent gamma mapping unit 110 and sub pixel rendering unit 120 easy. In detail, the input gamma converting unit linearizes and outputs the input image information RGBi in order for a nonlinear gamma characteristic of the input image information RGBi to be proportional to luminance.

In addition, an output gamma converting unit may be further included at the next stage of the sub pixel rendering unit 120.

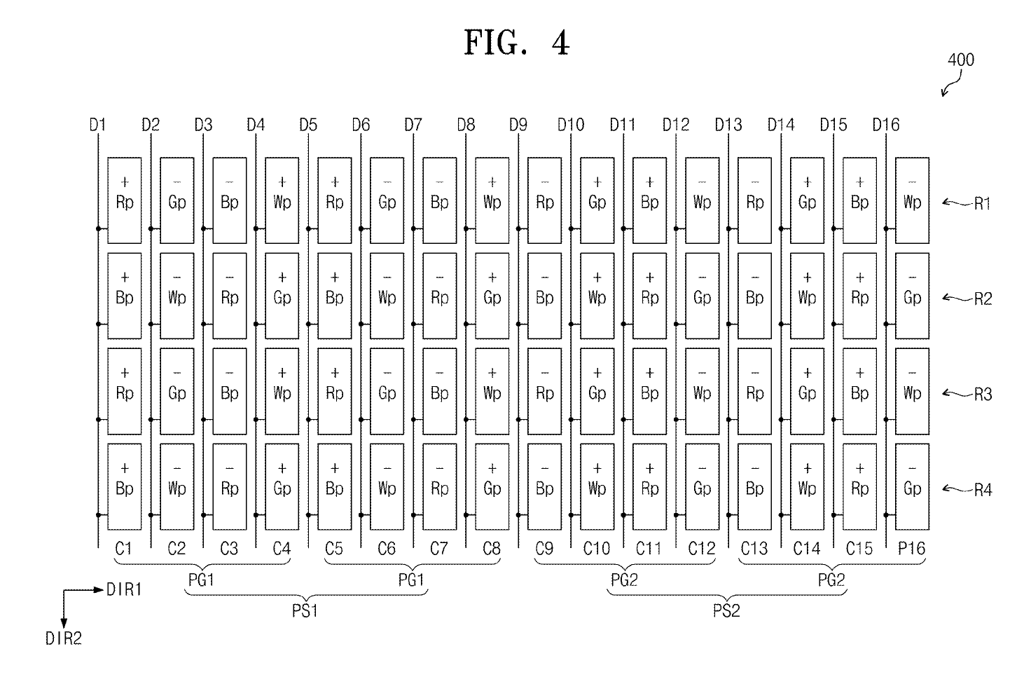

FIG. 4 is a plan view illustrating a part of the display panel according to an embodiment of the invention.

In an embodiment of the invention, pixels PX connected to the first to sixteenth data lines D1 to D16 are illustrated in FIG. 4. In FIG. 4, for convenience of explanation, a red pixel is denoted as Rp, a green pixel is denoted as Gp, a blue pixel is denoted as Bp, and a white pixel is denoted as Wp. Furthermore, in FIG. 4, ‘+’ represents pixels PX receiving data voltages having a positive (+) polarity and ‘−’ represents pixels PX receiving data voltages having a negative (−) polarity for the current frame.

Referring to FIG. 4, the pixels PX include a plurality of red pixels Rp displaying red, a plurality of green pixels Gp displaying green, a plurality of blue pixels Bp displaying blue, and a plurality of white pixels Wp displaying white. However, the invention is not limited thereto, and the pixels PX may further include yellow pixels, cyan pixels, and magenta pixels displaying yellow, cyan, and magenta, respectively.

The pixels PX are arrayed in the first and second directions DIR1 and DIR2, respectively, in a matrix configuration. A set of pixels sequentially arrayed along the first direction DIR1 among the pixels may be defined as a pixel row and a set of pixels sequentially arrayed along the second direction DIR2 may be defined as a pixel column. The display panel 400 may include a plurality of pixel rows and a plurality of pixel columns. FIG. 4 illustrates first to sixteenth pixel columns C1 to C16 among the plurality of pixel columns and first to fourth pixel rows R1 to R4 among the plurality of pixel rows among the plurality of pixel rows.

The red pixels Rp, the green pixels Gp, the blue pixels Bp, and the white pixels Wp may be sequentially and repetitively disposed from the first column at odd pixel rows among the pixel rows. The blue pixels Bp, the white pixels Wp, the red pixels Rp, and the green pixels Gp may be sequentially and repetitively disposed from the first column at even pixel rows among the pixel rows

The display panel 400 may include a plurality of pixel sets. Each of the plurality of pixel sets may be defined to have the plurality of pixel rows formed of 8i pixels.

In an example of the invention, i is 1. Accordingly, each of the plurality of pixel sets may be defined to have pixel rows formed of 8 pixels.

In an example of an embodiment of the invention, the pixel sets include first to fourth pixel rows R1 to R4. However, the invention is not limited thereto and the pixel sets may include all pixel rows defined along the second direction DIR2 of the display panel 400 as well as the first to fourth pixel rows R1 to R4.

FIG. 4 illustrates only first and second pixel sets PS1 and PS2, respectively, among the plurality of pixel sets. The first and second pixel sets PS1 and PS2, respectively, are alternatively disposed along the first direction DIR1.

The first pixel set PS1 includes a plurality of first pixel groups PG1. In an example of an embodiment of the invention, the first pixel set PS1 includes two first pixel groups PG1. The first pixel groups PG1 may include 4k (where k is a natural number) pixel columns. In an example of an embodiment of the invention, k may be 1. In this case, a first one of the first pixel groups PG1 may include pixels PX of the first to fourth pixel columns C1 to C4 and a second one of the first pixel groups PG1 may include pixels PX of the fifth to eighth pixel columns C5 to C8.

The second pixel set PS2 includes a plurality of second pixel groups PG2. In an example of an embodiment of the invention, the second pixel sets PS2 includes two second pixel groups PD2. The second pixel groups PG1 may include 4k pixel columns. In detail, a first one of the second pixel groups PG2 may include pixels PX of the ninth to twelfth pixel columns C9 to C12, respectively, and a second one of the second pixel groups PG2 may include pixels PX of the thirteenth to sixteenth pixel columns C13 to C16, respectively.

The red pixels Rp, the green pixels Gp, the blue pixels Bp, and the white pixels Wp are Wp are sequentially provided to the first and third pixel rows R1 and R3, respectively, of the first and second pixel groups PG1 and PG2, respectively. In addition, the blue pixels Bp, the white pixels Wp, the red pixels Rp and the green pixels Gp are sequentially provided to the second and fourth pixel rows R1 and R4, respectively,

Although not illustrated in the drawing, the pixels PX are connected to the gate lines G1 to Gn (see FIG. 1) corresponding thereto in a unit of row. In addition, the pixels PX are connected to the first to sixteenth data lines D1 to D16, respectively, corresponding thereto in a unit of column. In detail, the pixels PX corresponding to the first to sixteenth pixel columns C1 to C16, respectively, are connected to the first to sixteenth data lines D1 to D16, respectively.

The first to sixteenth data lines D1 to D16, respectively, receive data voltages having different polarities in a unit of two data lines from the display panel 400 so that flickering, moving vertical line and horizontal crosstalk phenomena are not observed.

For example, the first, fourth, fifth, eighth, tenth, eleventh, fourteenth, and fifteenth lines D1, D4, D5, D8, D10, D11, D14, and D15, respectively, receive data voltages of the positive polarity. The second, third, sixth, seventh, ninth, twelfth, thirteenth, and sixteenth data lines D2, D3, D6, D7, D9, D12, D13, and D16, respectively, receive data voltages of the negative polarity.

The data voltages of the positive and negative polarities are provided to the pixels PX through the first to sixteenth data lines D1 to D16, respectively.

Accordingly, an array of polarities in the row direction of the pixel columns of the first the first pixel group PG1 may be “+−−+” and an array of polarities in the row direction of the pixel columns of the second pixel group PG2 may be “−++−”. However, the invention is not limited thereto, and the array of the polarities in the row direction of the pixel columns may be varied.

When the data voltages are applied in this way, pixels PX displaying identical color in any one pixel row of the first and second pixel sets PS1 and PS2, respectively, have the same polarity and have a polarity different from that of pixels PX displaying identical color and disposed in an adjacent pixel row.

For example, the red pixels Rp of the first pixel row R1 of the first pixel set PS1 have the positive polarity, and the red pixels Rp of the second pixel row R2 of the first pixel set PS1 have the negative polarity.

In addition, when the data voltage is applied in this way, the polarities of the pixels displaying the identical color in each pixel row are converted by a single pixel set unit. In detail, the polarity of pixels arrayed in j-th pixel column of the first pixel set PS1 may be opposite to that of the pixels arrayed in the j-th pixel column of the second pixel set PS2.

For example, the red pixels Rp of the first pixel rows R1 of the first and second pixel set PS1 and PS2, respectively, have polarities inverted for a pixel set unit. As a result, the red pixels Rp of the first pixel rows R1 of the first pixel set PS1 have the positive polarity, while the red pixels Rp of the first pixel row R1 of the second pixel set PS2 have the negative polarity.

Polarities of the data voltages provided to the pixels PX of the display panel 400 illustrated in FIG. 4 represent polarities of the current frame. As described above, the data driving unit 300 inverts and outputs the polarities of the data voltages for each frame. Accordingly, the polarities of the data voltages provided to the pixels PX in the next frame will be inverted.

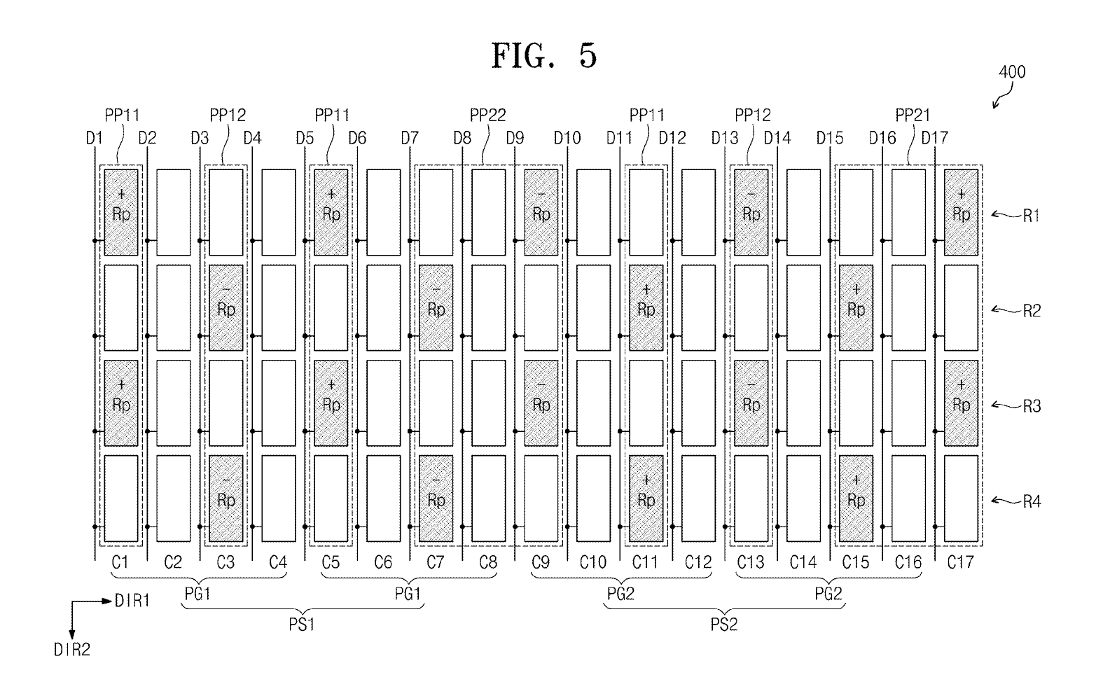

FIG. 5 shows driving states of pixels for displaying any one primary color among pixels illustrated in FIG. 4.

Typically, a luminance difference may occur between any one pixel to which a positive data voltage is applied and another pixel to which a negative data voltage having the same magnitude as the positive data voltage is applied. In particular, when the one pixel and the other pixel display the same color and are disposed sufficiently adjacent to each other, a user may observe an image in which a vertical line moves while a current frame is changed to the next frame. The phenomenon that the vertical line moves may be defined as the moving line mura. The moving line mura phenomenon may cause an issue not only in a case where a specific color is represented but in a case where all the pixels are driven such as a full white mode.

However, in an embodiment of the present invention, such a moving line mura does not occur. In detail, referring to FIG. 5, all the red pixels Rp of the first to seventeenth pixel columns C1 to C17, respectively, are driven and, accordingly, the display panel 400 displays a red image in full screen. In this case, first and second polarity patterns may occur in the display panel 400. The seventeenth pixel column C17 is a pixel column included in another first pixel set PS1 adjacent to the first direction DIR1 of the second pixel set PS2.

The first polarity pattern may be formed by an image displayed by one pixel column column receiving data voltages having the same polarity. The first polarity pattern may include a a first positive polarity pattern P11 and a first negative polarity pattern PP12. The first positive polarity pattern P11 is formed by an image displayed on a pixel column receiving data voltages of the positive polarity. For example, the pixel columns corresponding to the first positive polarity pattern PP11 may be the first, fifth and eleventh pixel column C1, C5, and C11, respectively. The first negative polarity pattern PP12 is formed by an image displayed on pixel columns receiving data voltages having the negative polarity. For example, the pixel columns corresponding to the first negative polarity pattern PP12 may be the third and thirteenth pixel columns C3 and C13.

The second polarity pattern may be formed by an identical color image displayed on two adjacent pixel columns receiving data voltages of the same polarity. The second polarity pattern may include a second positive polarity pattern PP21 and a second negative polarity pattern PP22. The second positive polarity pattern PP21 is formed by an identical color image displayed on two adjacent pixel columns receiving data voltages of the positive polarity. For example, pixel columns corresponding to the second positive polarity pattern PP21 may be the fifteenth and seventeenth pixel columns C15 and C17, respectively. The second negative polarity pattern PP22 is formed by an identical image displayed on two adjacent pixel columns receiving data voltages of the negative polarity. For example, pixel columns corresponding to the second negative polarity pattern PP22 may be the seventh and ninth pixel columns C7 and C9, respectively.

Even though the first positive and negative polarity patterns PP11 and PP12, respectively, are displayed alternatively with one pixel column in-between, since each of the first positive and negative polarity patterns PP11 and PP12, respectively, is displayed with only one pixel column, the first positive and negative polarity patterns PP11 and PP12, respectively, are not observed by the user. Accordingly, even though the polarity of data voltage is inverted as the the current frame is changed to the next frame, the moving vertical line due to the first positive and negative polarity patterns PP11 and PP12, respectively, may not be observed.

Even though each of the second positive and negative polarity patterns PP21 and PP22, respectively, is displayed by two adjacent pixel columns and may be observed, since the second positive and negative polarity patterns PP21 and PP22, respectively, are displayed with eight pixel columns in-between, the user may not observe the moving vertical line due to the second positive and negative polarity patterns PP21 and PP22 even when the polarities of the data voltages are inverted as the current frame is changed to the next frame.

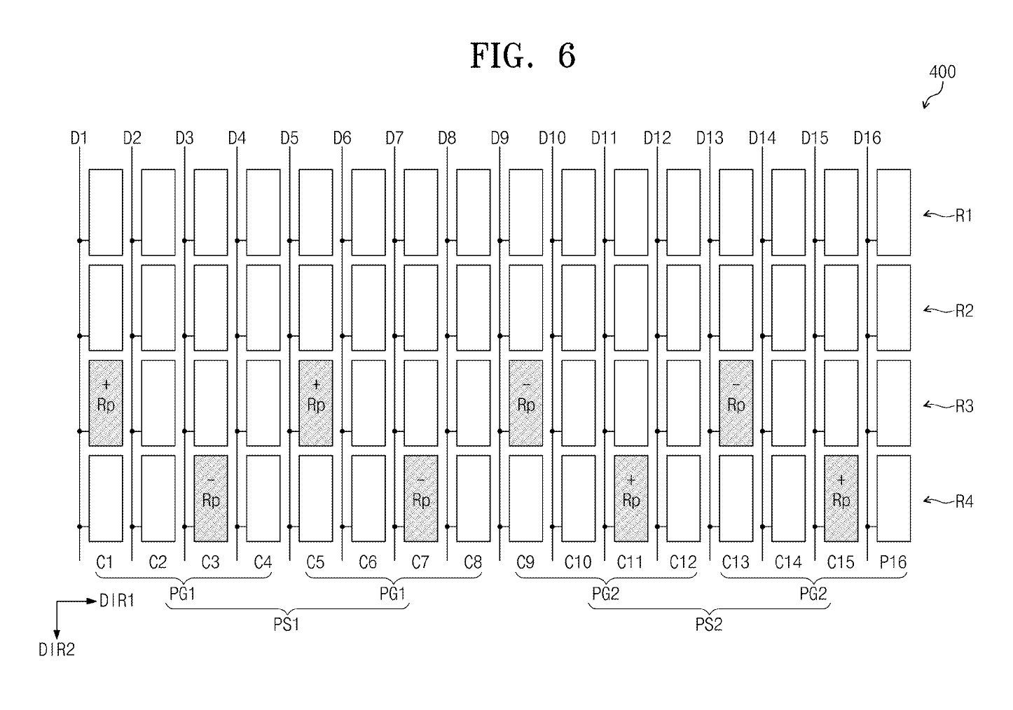

FIG. 6 is a view illustrating a driven state of pixels when primary colors are displayed on any portion of pixel rows among pixels illustrated in FIG. 5.

Typically, during one horizontal period in which pixels PX of each pixel row are driven, when polarities of data voltages applied to pixels connected to the identical gate line are identical, a ripple occurs in the common voltage due to a coupling phenomenon of the common electrode with the data lines.

When the polarities of the data voltages are positive, a ripple may occur in the common voltage in a positive direction. When the polarities of the data voltages are negative, a ripple may occur in the common voltage in a negative direction.

For example, in order to display red on any one region, when red pixels Rp in the one region are driven and accordingly a ripple occurs in the common voltage, a luminance difference is observed between luminance of an adjacent region adjacent to the one region in the first direction DIR1 and luminance of a lower region adjacent to the adjacent region in the second direction DIR2, and a crosstalk phenomenon may occur.

However, in an embodiment of the invention, such a horizontal crosstalk phenomenon does not occur. In detail, referring to FIG. 6, the red pixels Rp of the third and fourth pixel rows R3 and R4, respectively, are driven and, accordingly, a red image is displayed on a region corresponding to the third and fourth pixel rows R3 and R4, respectively, of the display panel 400.

In this case, the red pixels Rp disposed in the third pixel row R3 of the first pixel set PS1 receive data voltages of the positive polarity, and the red pixels Rp disposed in the third pixel row R3 of the second pixel set PS2 receive data voltages of the negative polarity. Accordingly, since effects of the data voltages of the positive and negative polarities to the common voltage cancel each other, ripple does not occur in the common voltage. As a result, the horizontal crosstalk phenomenon due to the ripple in the common voltage may be prevented.

Similarly, red pixels Rp disposed in the fourth pixel row R4 of the first pixel set PS1 receive data voltages of the negative polarity, and red pixels Rp disposed in the fourth pixel row R4 of the second pixel set PS2 receive data voltages of the positive polarity. Accordingly, since effects of the data voltages of the positive polarity and the data voltages of the negative polarity cancel each other, a ripple does not occur in the common voltage. As a result, a horizontal crosstalk phenomenon due to the ripple in the common voltage may be prevented. In other words, since the polarities of the pixels displaying identical color in each pixel row are inverted in a unit of one pixel set, the horizontal crosstalk phenomenon may be prevented.

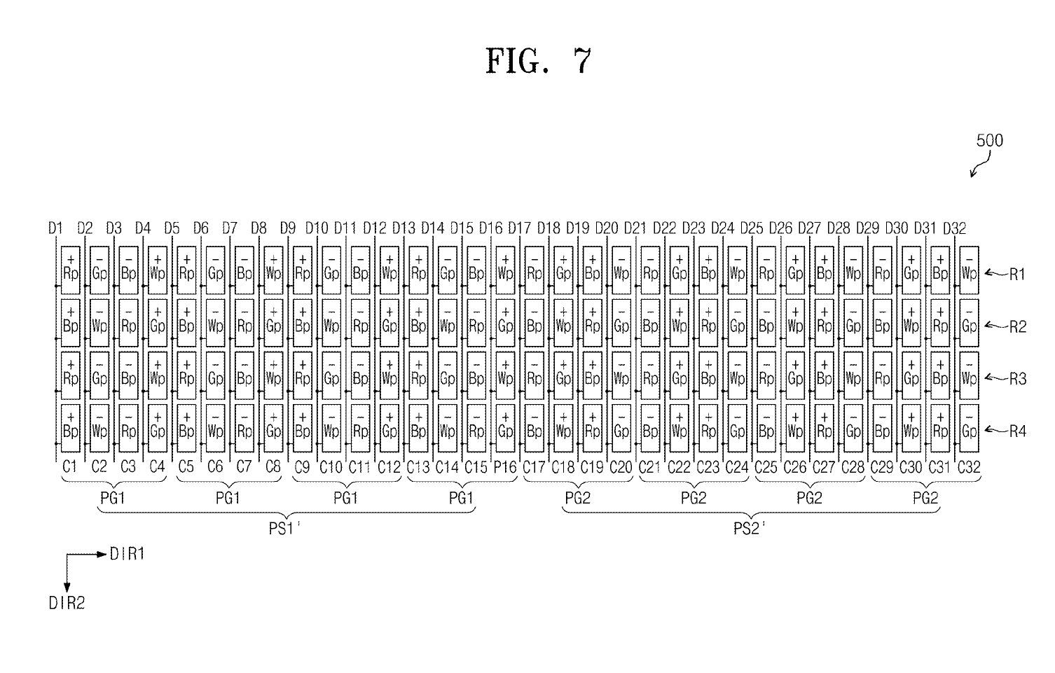

FIG. 7 is a plan view illustrating a part of a display panel according to another embodiment of the invention.

Since a display panel 500 illustrated in FIG. 7 is the same as the display panel 400 illustrated in FIG. 4 except that the number of pixel columns included in the first and second pixel sets PS1′ and PS2′, respectively, is different, the overlapping description will be omitted.

In another embodiment of the invention, i is 2. Accordingly, each of the first and second pixel sets PS1′ and PS2′, respectively, may be defined to include a plurality of pixel rows formed of 16 pixels PX.

The first and second pixel sets PS1′ and PS2′, respectively, are alternatively disposed along the first direction DIR1. The first and second pixel sets PS1′ and PS2′, respectively, may include not only first to fourth pixel rows R1 to R4, respectively, but also all of the pixel rows defined in the display panel 400.

The first pixel set PS1′ includes a plurality of first pixel groups PG1. In an exemplary embodiment of the invention, the first pixel set PS1′ includes two first pixel groups PG1. The first pixel group PG1 may include 4k (where k is a natural number) pixel columns. In an embodiment of the invention, k is 1. In this case, a first one of the first pixel groups PG1 may include pixels PX of first to fourth pixel columns C1 to C4, respectively, and a second one of the first pixel groups PG1 may include pixels PX of fifth to eighth pixel columns C5 to C8, respectively.

The second pixel set PS2′ includes a plurality of second pixel groups PG2. In an exemplary embodiment of the invention, the second pixel set PS2′ includes two second pixel groups PG2. The second pixel groups PG2 may include 4k pixel columns. In detail, a first one one of the second pixel groups PG2 may include pixels PX of ninth to twelfth pixel columns C9 to C12, respectively, and a second one of the second pixel groups PG2 may include pixels PX of thirteenth to sixteenth pixel columns C13 to C16, respectively.

The red, green, blue, and white pixels Rp, Gp, Bp, and Wp, respectively, are provided in the order to the first and third pixel rows R1 and R3, respectively, of the first and second pixel groups PG1 and PG2, respectively. Furthermore, the blue, white, red, and green pixels Bp, Wp, Rp and Gp, respectively, are sequentially and repetitively provided to the second and fourth pixel rows R2 and R4, respectively

Although not illustrated in the drawings, the pixels PX are connected to the gate lines G1 to Gn corresponding thereto in a unit of row. In addition, the pixels PX are connected to the first to sixteenth data lines D1 to D16, respectively, corresponding thereto in a unit of a column. In detail, pixels PX correspond to the first to sixteenth pixel columns C1 to C16, respectively, are connected to the first to sixteenth data lines D1 to D16, respectively.

The first to sixteenth data lines D1 to D16, respectively, receive, from the display panel 400, data voltages having different polarities in a unit of two data lines so that the flickering, moving vertical line and horizontal crosstalk phenomena are observed.

For example, the first, fourth, eighth, tenth, eleventh, fourteenth and fifteenth D1, D4, D5, D8, D10, D11, D14, and D15, respectively, receive data voltages of the positive polarity. The second, third, sixth, seventh, ninth, twelfth, thirteenth and the sixteenth data lines D2, D3, D6, D7, D9, D12, D13, and D16, respectively, receive voltages of the negative polarity.

The data voltages of the positive and negative polarities are provided to the pixels PX through the first to sixteenth data lines D1 to D16, respectively.

Accordingly, an array of polarities in the row direction of the pixel columns of the first pixel group PG1 may be “+−−+” and an array of polarities in the row direction of the pixel columns of the second pixel group PG2 may be “−++−”. However, the invention is not limited thereto, and the array of the polarities in the row direction of the pixel columns may be varied.

When the data voltages are applied in this way, pixels PX displaying identical color in any one pixel row of the first and second pixel sets PS1′ and PS2′, respectively, have the same polarity and have a different polarity from that of pixels PX displaying identical color and disposed in adjacent pixel rows.

For example, the red pixels Rp of the first pixel row R1 of the first pixel set PS1′ have the positive polarity and the red pixels Rp of the second pixel row R2 of the first pixel set PS1′ have the negative polarity.

In addition, when the data voltage is applied in this way, the polarities of the pixels displaying the identical color in each pixel row are converted for a single pixel set unit. In detail, the polarities of pixels arrayed in j-th pixel column of the first pixel set PS1′ may be opposite to those of the pixels arrayed in the j-th pixel column of the second pixel set PS2′.

For example, the red pixels Rp of the first pixel rows R1 of the first and second pixel set PS1 and PS2, respectively, have polarities inverted for a pixel set unit. As a result, the red pixels Rp of the first pixel rows R1 of the first pixel set PS1′ have the positive polarity, while the red pixels Rp of the first pixel row R1 of the second pixel set PS2′ have the negative polarity.

Polarities of the data voltages provided to the pixels PX of the display panel 400 illustrated in FIG. 3 represent polarities of the current frame. As described above, the data driving unit 300 inverts and outputs the polarities of the data voltages for each frame. Accordingly, the polarities of the data voltages provided to the pixels PX in the next frame will be inverted.

As indicated earlier, FIG. 5 shows driving states of pixels for displaying any one primary color among pixels illustrated in FIG. 4.

Typically, a luminance difference may occur between any one pixel to which a positive data voltage is applied and another pixel to which a negative data voltage having the same magnitude as the positive data voltage is applied. In particular, when the one pixel and the other pixel display the same color and are disposed sufficiently adjacent to each other, a user may observe an image in which a vertical line moves while a current frame is changed to the next frame. The phenomenon that the vertical line moves may be defined as the moving line mura. The moving line mura phenomenon may cause an issue not only in a case where a specific color is represented but also in a case where all of the pixels are driven, such as a full white mode.

However, in an embodiment of the present invention, such a moving line mura does not occur, In detail, referring to FIG. 5, all of the red pixels Rp of the first to sixteenth pixel columns C1 to C16, respectively, are driven and accordingly the display panel 400 displays a red image in full screen. In this case, first and second polarity patterns may occur in the display panel 400.

The first polarity pattern may be formed by an image displayed by one pixel column receiving data voltages having the same polarity. The first polarity pattern may include a a first positive polarity pattern P11 and a first negative polarity pattern PP12. The first positive polarity pattern P11 is formed by an image displayed on a pixel column receiving data voltages of the positive polarity. For example, the pixel column corresponding to the first positive polarity pattern PP11 may be the first, fifth and eleventh pixel column C1, C5, and C11, respectively. The first negative polarity pattern PP12 is formed by an image displayed on pixel columns receiving data voltages having the negative polarity. For example, the pixel columns corresponding to the first negative polarity pattern PP12 may be the third and thirteenth pixel columns C3 and C13, respectively.

The second polarity pattern may be formed by an identical color image displayed on two adjacent pixel columns receiving data voltages of the same polarity. The second polarity pattern may include a second positive polarity pattern PP21 and a second negative polarity pattern PP22. The second positive polarity pattern PP21 is formed by an identical color image displayed on two adjacent pixel columns receiving data voltages of the positive polarity. For example, pixels columns corresponding to the second positive polarity pattern PP21 may be the fifteenth and seventeenth pixel columns C15 and C17, respectively. The second negative polarity pattern PP22 is formed by an identical image displayed on two adjacent pixel columns receiving data voltages of the negative polarity. For example, pixel columns corresponding to the second negative polarity pattern PP22 may be the seventh and the ninth pixel columns C7 and C9, respectively.

Even though the first positive and negative polarity patterns PP11 and PP12 are displayed alternatively with one pixel column in-between, since each of the first positive and negative polarity patterns PP11 and PP12, respectively, is displayed with only one pixel column, the first positive and negative polarity patterns PP11 and PP12, respectively, are not observed by the user. Accordingly even though the polarity of data voltage is inverted as the current frame is is changed to the next frame, the moving vertical line due to the first positive and negative polarity patterns PP11 and PP12, respectively, may not be observed.

Even though each of the second positive and negative polarity patterns PP21 and PP22, respectively, is displayed by two adjacent pixel columns and may be observed, since the second positive and negative polarity patterns PP21 and PP22, respectively, are displayed with eight pixel columns in-between, the user may not observe the moving vertical line due to the second positive and negative polarity patterns PP21 and PP22, respectively, even when the polarities of the data voltages are inverted as the current frame is changed to the next frame.

FIG. 6 shows driving states of pixels in a case where primary colors are displayed on any portion of pixel rows among the pixels illustrated in FIG. 5.

Typically, during one horizontal period in which pixels PX of each pixel row are driven, when polarities of data voltages applied to pixels connected to the identical gate line are identical, a ripple occurs in the common voltage due to a coupling phenomenon of the common electrode with the data lines.

When the polarities of the data voltages are positive, a ripple may occur in the common voltage in a positive direction. When the polarities of the data voltages are negative, a ripple may occur in the common voltage in a negative direction.

For example, in order to display red on any one region, when red pixels Rp in the one region are driven and accordingly a ripple occurs in the common voltage, a luminance difference is observed between luminance of an adjacent region adjacent to the one region in the first direction DIR1 and luminance of a lower region adjacent to the adjacent region in the second direction DIR2, and a crosstalk phenomenon may occur.

However, in an embodiment of the invention, such a horizontal crosstalk phenomenon does not occur. In detail, referring to FIG. 6, the red pixels Rp of the third and fourth pixel rows R3 and R4, respectively, are driven and accordingly a red image is displayed on a region corresponding to the third and fourth pixel rows R3 and R4, respectively, of the display panel 400.

In this case, the red pixels Rp disposed in the third pixel row R3 of the first pixel set PS1 receive data voltages of positive polarity, and the red pixels Rp disposed in the third pixel row R3 of the second pixel set PS2 receive data voltages of the negative polarity. Accordingly, since effects of the data voltages of the positive and negative polarities on the common voltage cancel each other, ripple does not occur in the common voltage. As a result, the horizontal crosstalk phenomenon due to the ripple in the common voltage may be prevented.

Similarly, red pixels Rp disposed in the fourth pixel row R4 of the first pixel set PS1 receive data voltages of the negative polarity, and red pixels Rp disposed in the fourth pixel row R4 of the second pixel set PS2 receive data voltages of the positive polarity. Accordingly, since effects of the data voltages of the positive polarity and the data voltages on the negative polarity cancel each other, a ripple does not occur in the common voltage. As a result, a horizontal crosstalk phenomenon due to the ripple in the common voltage may be prevented. In other words, since the polarities of the pixels displaying identical color in each pixel row are inverted in a unit of one pixel set, the horizontal crosstalk phenomenon may be prevented.

FIG. 7 illustrates only first and second pixel sets PS1′ and PS2′ among the plurality of pixel sets. The first and second pixel sets PS1′ and PS2′, respectively, are alternatively disposed along the first direction DIR1.

The first and second pixel sets PS1′ and PS2′, respectively, may include not only first to fourth pixel rows R1 to R4, respectively, but also all the pixel rows defined in the display panel 400.

In an example of the invention, the first pixel set PS1′ includes four of the first pixel groups PG1. The first pixel groups PG1 may include 4k (where k is a natural number) pixel columns. In an embodiment of the invention, k is 1. In this case, first to fourth of the pixel group PG1 may include pixels PX of the first to fourth pixel columns C1 to C4, respectively, pixels PX of fifth to eighth pixel columns C5 to C8, respectively, pixels of ninth to twelfth pixel columns C9 to C12, respectively, and pixels PX of the thirteenth to sixteenth pixel columns C13 to C16, respectively.

In another example of the invention, the second pixel set PS2′ includes four second pixel groups PG2. The second pixel groups PG2 may include 4k pixel columns. In detail, first to fourth ones of the second pixel groups PG2 may include pixels PX of the seventeenth to 20th pixel columns C17 to C20, respectively, pixels PX of 21st to 24th pixel columns C21 to C24, respectively, pixels of 25th to 28th pixel columns C25 to C28, respectively, and pixels PX of the 29th to 32nd pixel columns C29 to C32, respectively

Although not illustrated in the drawings, the pixels PX are connected to the gate lines G1 to Gn (see FIG. 1) corresponding thereto in a unit of row. In addition, the pixels PX are are connected to the first to 32nd data lines D1 to D32, respectively, corresponding thereto in a unit of column. In detail, the pixels PX corresponding to the first to 32nd pixel columns c1 to c32, respectively, are connected to the first to 32nd data lines D1 to D32, respectively.

The first to 32nd data lines D1 to D32, respectively, receive from the display panel 400 data voltages having different polarities in a unit of two data lines so that the flickering, moving vertical line and horizontal crosstalk phenomena are not observed.

For example, first, fourth, fifth, ninth, tenth, twelfth, thirteenth, and sixteenth data lines D1, D4, D5, D9, D10, D12, D13, and D16, respectively, connected to the first pixel sets PS1′ receive data voltages of the positive polarity. In addition, the second, third, sixth, tenth, eleventh, fourteenth, and fifteenth data lines D2, D3, D6, D10, D11, D14, and D15, respectively, connected to the first pixel set PS1′ receive data voltages of the negative polarity.

Similarly, the 18th, 19th, 22nd, 23rd, 26th, 27th, 30th and 31st data lines D18, D19, D22, D23, D26, D27, D30, and D31, respectively, connected to the second pixel set PS2′ receive data voltages of the positively polarity. In addition, the 17th, 20th, 21st, 24th, 25th, 28th, 29th, and 32nd data lines D17, D20, D21, D24, D25, D28, D29, and D32, respectively, connected to the second pixel set PS2′ receive data voltages of the negative polarity.

When the data voltages are applied in this way, pixels PX displaying identical color in any one pixel row of the first and second pixel sets PS1′ and PS2′, respectively, have the same polarity, and have different polarity from that of the pixels PX displaying the identical color and disposed on adjacent pixel rows.

For example, red pixels Rp of the first pixel row R1 of the first pixel set PS1′ have the positive polarity and red pixels Rp of the second pixel row R2 of the first pixel set PS1′ have the negative polarity.

In addition, when the data voltages are applied in this way, polarities of the pixels PX displaying identical color in each pixel row are inverted in a unit of one pixel set unit. In detail, polarities of pixels arrayed in a j-th pixel column of the first pixel set PS1′ may be opposite to those of pixels arrayed in j-th pixel column of the second pixel set PS2′.

For example, red pixels Rp of the first pixel row R1 have their polarities inverted for a pixel set unit. As a result, the red pixels Rp of the first pixel row R1 of the first pixel set PS1′ have positive polarity and the red pixels Rp of the first pixel row R1 of the second pixel set PS2′ have the negative polarity.

For example, the red pixels Rp of the first pixel rows R1 of the first and second pixel set PS1′ and PS2′, respectively, have polarities inverted for a pixel set unit. As a result, the red pixels Rp of the first pixel rows R1 of the first pixel set PS1′ have the positive polarity, while the red pixels Rp of the first pixel row R1 of the second pixel set PS2′ have the negative polarity.

The polarities of the data voltages provided to the pixels PX of the display panel 400 illustrated in FIG. 7 represent current polarities of a current frame. As described above, the data driving unit 300 inverts and outputs polarities of the data voltages for each frame. Accordingly, the polarities of the data voltages provided to the pixels PX in the next frame may be inverted.

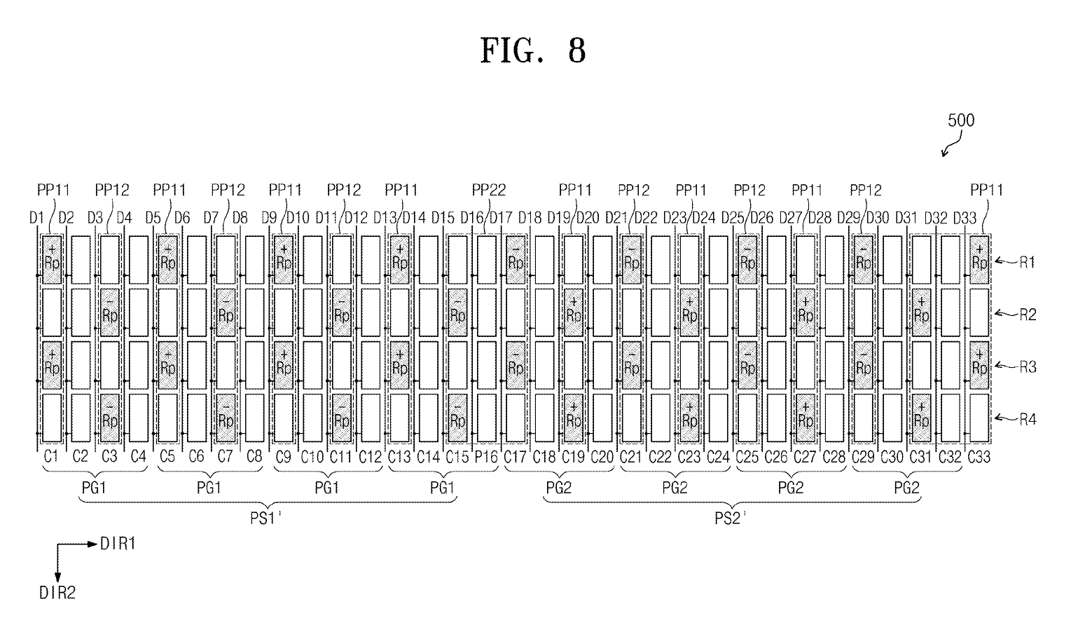

FIG. 8 illustrates driving states of pixels when any portion of pixel rows among the pixels illustrated in FIG. 7 displays primary colors.

In an embodiment of the invention, the foregoing moving line mura does not occur. In detail, referring to FIG. 8, all of the red pixels Rp of the first to 33rd pixel columns C1 C1 to C33, respectively, are driven and accordingly the display panel 400 displays a red image in full screen. In this case, first and second polarity patterns may occur in the display panel 400. The 33rd pixel column C33 is a pixel column belonging to another first pixel set PS1′ provided to the right side of the second pixel set PS2′, which is in the rightmost side in FIG. 8.

As described above, even though the first positive and negative polarity patterns PP11 and PP12, respectively, are displayed alternatively with one pixel column in-between, since each of the first positive and negative polarity patterns PP11 and PP12, respectively, is displayed with only one pixel column, the first positive and negative polarity patterns PP11 and PP12, respectively, are not observed by the user. Accordingly even though the polarity of data voltage is inverted as the current frame is changed to the next frame, a user may not observe the moving vertical line due to the first positive and negative polarity patterns PP11 and PP12, respectively.

On the other hand, in an embodiment of the invention, even though each of the second positive and negative polarity patterns PP21 and PP22, respectively, is displayed by two adjacent pixel columns and may be observed, since the second positive and negative polarity patterns PP21 and PP22, respectively, are displayed with eight pixel columns in-between, the user may not observe the moving vertical line due to the second positive and negative polarity patterns PP21 and PP22, respectively, even when the polarities of the data voltages are inverted as the current frame is changed to the next frame.

In particular, as the number of pixels PX disposed between the second positive and negative polarity patterns PP21 and PP22, respectively, is greater, it is more difficult for the user to recognize movement of the vertical line due to a luminance difference of the second positive and negative polarity patterns PP21 and PP22, respectively.

Furthermore, as described above relative to FIG. 6, since polarities of the pixels PX displaying the same color in each pixel row in the display panel illustrated in FIG. 7 are inverted in a unit of one pixel set, the horizontal crosstalk phenomenon may be prevented.

A display device according to an embodiment of the inventive concept can improve display quality by improving a moving line mura phenomenon and a horizontal crosstalk phenomenon.

The above-disclosed subject matter is to be considered illustrative and not restrictive, and the appended claims are intended to cover all such modifications, enhancements, and other embodiments which fall within the true spirit and scope of the invention. Thus, to the maximum extent allowed by law, the scope of the invention is to be determined by the broadest permissible interpretation of the following claims and their equivalents, and shall not be restricted or limited by the foregoing detailed description.

What is claimed is:

1. A display apparatus, comprising:
a display panel comprising a plurality of pixel sets;
wherein each of the plurality of pixel sets comprises a plurality of pixel rows formed of 8i pixels (where i is a natural number) and each of the pixels is any one of first to fourth pixels displaying different colors;
wherein pixels displaying identical color in a first pixel row among the pixel rows of each of the plurality of pixel sets have identical polarity, and have different polarities from those of pixels displaying identical color and disposed in a second pixel row adjacent to the first pixel row; and
wherein polarities of the pixels displaying identical color in each pixel row are inverted in a unit of one pixel set.

2. The display apparatus of claim 1, wherein the plurality of pixel sets comprise first and second pixel sets disposed adjacent to each other in a row direction; and
wherein polarities of pixels arrayed in a j-th pixel column (where j is a natural number) of the first pixel set are opposite to those of pixels arrayed in j-th pixel column of the second pixel set.

3. The display apparatus of claim 1, wherein the first pixel set comprises a plurality of first pixel groups having 4k pixel columns (where k is a natural number) and the second pixel set comprises a plurality of second pixel groups having 4k pixel columns; and
wherein polarities of pixels arrayed in an l-th pixel column (where l is a natural number) of the first pixel group are opposite to those of pixels arrayed in an l-th pixel column of the second pixel group.

4. The display apparatus of claim 3, wherein k is 1;
wherein first to fourth pixels in each first pixel row of the first and second pixel groups are provided in the order of the first, second, third, and fourth pixels; and
wherein first to fourth pixels in each second pixel row of the first and second pixel groups are provided in the order of third, fourth, first, and second pixels.

5. The display apparatus of claim 4, wherein an array of polarities in the row direction of the pixel columns of the first pixel group is “+−−+” and an array of polarities in the row direction of the pixel columns of the second pixel group is “−++−”.

6. The display apparatus of claim 1, wherein the first to fourth pixels display red, green, blue, and white, respectively.

7. The display apparatus of claim 1, further comprising a data driving unit applying data voltages to the pixel columns, respectively.

8. The display apparatus of claim 7, wherein the data driving unit provides data voltages having different polarities in a unit of two pixel columns.

9. The display apparatus of claim 8, wherein the data driving unit inverts the polarities of the data voltages for each frame.

10. The display apparatus of claim 9, further comprising a timing controller comprising a gamma mapping unit mapping image information having three primary colors received from outside to create RGBW signals, and a sub pixel rendering unit converting the RGBW signals into output image data through resample filtering; and
wherein the data driving unit converts the output image data into the data voltages.
